(19) United States
(12) Patent Application Publication
(10) Pub. No.: US 2021/0251384 A1
(43) Pub. Date: Aug. 19, 2021

(54) RENTAL CAR AND FLEET KEY RETENTION

(71) Applicant: Giovanni Mattera, Oviedo, FL (US)

(72) Inventor: Giovanni Mattera, Oviedo, FL (US)

(21) Appl. No.: 16/795,527

(22) Filed: Feb. 19, 2020

(51) Int. Cl. A47B 81/00; G06K 19/077

(52) U.S. Cl. CPC A47B 81/00; B60R 2325/105; G06K 19/07758

(57) ABSTRACT

A key fob locking device for providing a rental car and fleet key and key fob retention is disclosed. A enclosing case holding two identical key fobs is used to keep the pair of key fobs together. The case includes a locking mechanism to hold a pivoting top piece in place to retain the fobs therein. The sides of the fobs having buttons used by a driver to initiate commands to the corresponding vehicle may be accessed through an open side of the case.

### TECHNICAL FIELD

This application relates in general to an article of manufacture for providing a rental car and fleet key and key fob retention.

### BACKGROUND

Car rental fleets and auctions currently have a huge theft problem with the second keys being stolen off the key rings. The internet has created a huge market for these key fobs that can be refurbished and resold. All vehicles when built come with 2 sets of keys. The logistical problem for these car rental companies is if they separate them to prevent theft is how do they keep track of the keys. Enterprise™ Car Rental, as an example, maintains 1 million vehicles in the fleet at a time. Currently, they try to deter theft by using a metal strap to band the 2 fobs together by the emergency keys. The problem still exists because it is the fob that is the valuable part, so they take just the fob which is easily detached. The present invention attempts to address the existing limitations in an article of manufacture for providing a rental car and fleet key and key fob retention according to the principles and example embodiments disclosed herein.

### SUMMARY

In accordance with the present invention, the above and other problems are solved by providing an article of manufacture for providing a rental car and fleet key and key fob retention.

In one embodiment, the present invention is a key fob locking device for providing a rental car and fleet key and key fob retention. A retention case holding two identical key fobs is used to keep the pair of key fobs together. The case includes a locking mechanism to hold a pivoting top piece in place to retain the fobs therein. The sides of the fobs having buttons used by a driver to initiate commands to the corresponding vehicle may be accessed through an open side of the case.

The great utility of the invention is that an article of manufacture may provide an article of manufacture for providing a rental car and fleet key and key fob retention that discourages loss of programmable key fobs when customers return fleet vehicles.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1a-b illustrates various embodiments of a rental car and fleet key and key fob that may be used according to the present invention.

FIG. 2 illustrates one possible embodiment for an article of manufacture may provide an article of manufacture for providing a rental car and fleet key and key fob retention according to the present invention.

FIG. 3 illustrates another possible embodiment for an article of manufacture may provide an article of manufacture for providing a rental car and fleet key and key fob retention according to the present invention.

FIG. 4 illustrates an example embodiment for an article of manufacturer for providing a rental car and fleet key and key fob retention utilizing a custom headed screw to function as a locking device according to the present invention.

### DETAILED DESCRIPTION

This application relates in general an article of manufacture for providing a rental car and fleet key and key fob retention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “driver” refers to an entity, e.g. a human, that operates a device according to the present invention in order to bring about a desired effect or outcome, particularly provide the user an ability to support an instrument. In a particular case, the user is one that operates an automobile. For such a user, the terms “user” and “driver” may be used herein interchangeably.

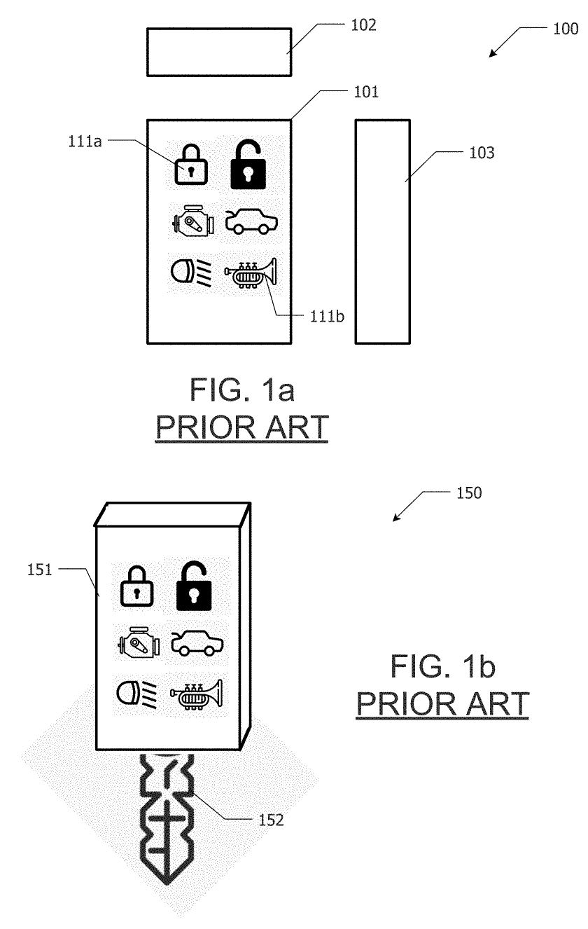

In general, the present disclosure relates general an article of manufacture for providing a rental car and fleet key and key fob retention. To better understand the present invention, FIGS. 1a-b represent various embodiments of a rental car and fleet key and key fob that may be used according to the present invention. FIG. 1a illustrates a car key fob 100 that may be used with a vehicle that uses a start/stop button to operate the vehicle's engine. Typically, the key fob 100 needs to be inside or in close proximity to the vehicle for the vehicle to detect its presence. Each key fob 100 possesses a unique ID that must match the ID expected by the vehicle to permit the vehicle to start.

FIG. 1a shows a front view 101, a side view 102, and a top view 103. On the front of the key fob 100. On the front face of the key fob 100 is a set of buttons 110a-n that are typically labeled with icons describing their function. When driver depresses a button, an electronic signal is sent to the vehicle to command an instruction to be executed. Example buttons may include lock, unlock, start engine, open trunk, turn on/off lights, and panic alarm. These are well known functions present in a vehicle that may be controlled remotely using the key fob 100.

FIG. 1b shows another example of a key fob 150 that has the fob 151 as described above with respect to FIG. 1a and a physical key 152 that is used in a door lock and ignition to open and start the engine. All of the buttons and remote functions behave as above, only the vehicle may only start and operate with the key 152 being inserted into the ignition and match the locking mechanism to permit it to rotate into a start and running position.

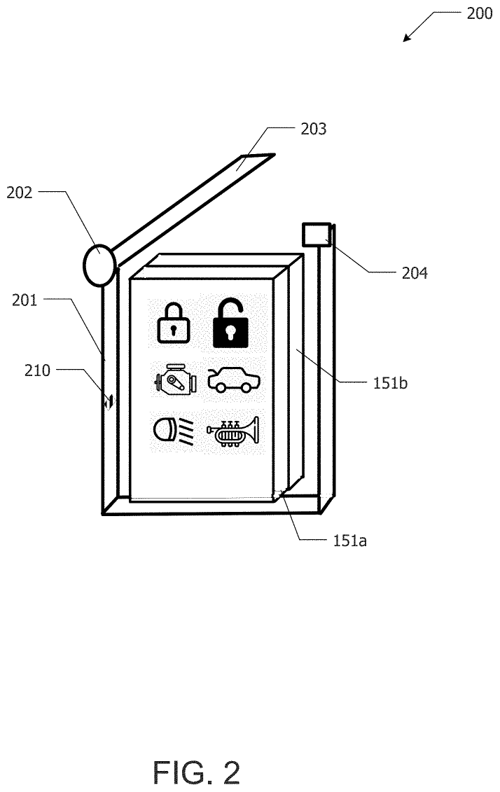

FIG. 2 illustrates one possible embodiment for an article of manufacture may provide an article of manufacture for providing a rental car and fleet key and key fob retention according to the present invention.

The present invention not only keeps the two key 151a-b together, but also helps assist with the problem of customers leaving the car rental return area with keys still in their possession and with the incorporation of another device find misplaced keys. The goal is to save 10 of millions of dollars currently being spent on making lost or stolen keys, lost time and money paying employees to deal with these key issues and most importantly less downtime to these vehicles with lost or stolen keys.

The present invention is a case that will be custom made to the manufactures specifications of the keys 152 and fobs 100 that will lock together so they cannot be separated. It also store a tracking device 160, such as an RFID chip or similar device, that will alert the car rental company if someone has forgotten to leave the keys with the car when returning the vehicle and a device that can be used to find misplaced keys using the customers cell phone. The case 201 can be painted to display the company's logo and in company colors. The invention will have a small lock 204 that will have a key that will be specific to the brand so the entire country can use one master key to open the case when needed or when the car is being removed from service.

The case 201 is shaped to exactly match the outside perimeter of the key fob 101a-b. The case 201 is sized to accept 2 identical key fobs 101a-b placed back to back and then inserted into the case. The case 201 is shown if FIG. 2 to be a flat band that wraps around the two key fobs 101a-b; however, in some embodiments, the case may possess a raised lip to retain the front sides of the fobs while they are in the case 201. The case also as a removable top piece 203 that is attached to the case 201 at one of its end and pivots up and down to close the case 201 when the two fobs 101a-b are contained therein. The opposite end of the top piece 203 engages a locking mechanism 204 that prevents drivers from being able to remove the fobs 101a-b from the case 201 without authorization. An eyelet 202 for attaching the case 201 to a key ring or similar device along with an identification tag (not shown) may be located at the pivot point where the case 201 and the top piece join together. While the locking mechanism 204 is shown as a mechanical clasping lock, other mechanisms that deter or prevent the case from being opened, whether mechanical, electrical, or the like may be used to secure the case closed with the key fobs therein.

Once the two key fobs 101a-b are inserted into the case 201, the top piece 203 may be locked into place. The buttons 110a-n are accessible through an open side of the case 201 permitting a driver to utilize the fob in the ordinary manner. Because two identical fobs are contained within the case 201 and they are both configured to control the same vehicle, the driver may utilize either of the two fobs while using the vehicle. An RFID tag 210 or similar device may be attached to an inside surface of the case 201 to permit the case and two fobs to be tracked when a vehicle is returned by a driver.

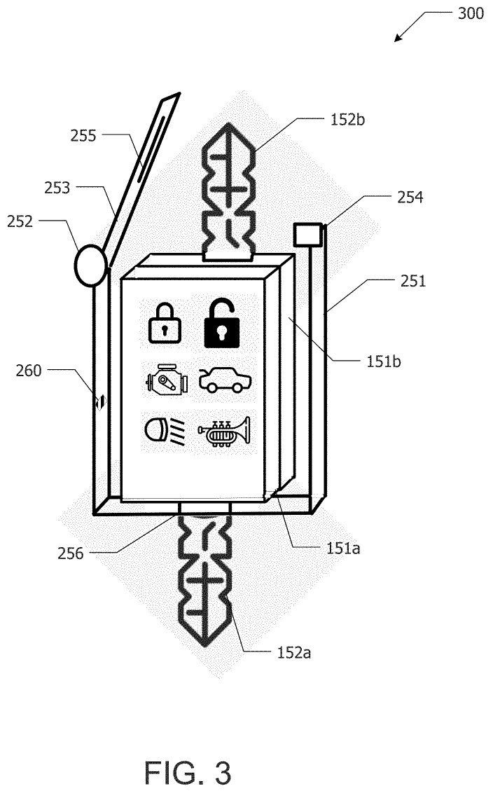

FIG. 3 illustrates another possible embodiment for an article of manufacture may provide an article of manufacture for providing a rental car and fleet key and key fob retention according to the present invention. The case 251 and key fob pair 151a-b function in the same manner as the case and fobs described above with reference to FIG. 2. In this embodiment, the key fobs 151a-b each consist of a fob unit 151 and an attached key 152a-b for use in the vehicle.

The case 251 wraps around the two fobs 151a-b in the same manner as above except that the attached keys 152a-b passing through openings 255-256 in the case that permits the attached keys to extend out of the case 251. Because the attached keys 152a-b must be able to be inserted into a door lock cylinder and into an ignition, the two copies of the key cannot be aligned to exit the case on the same side. The embodiment shows the attached keys 152a-b extending out of the bottom of the case 256 and extending through the top piece 253 using an opening 255. In this arrangement, the key may be inserted into the door lock and the ignition while the second key is out of the way extending in the opposite direction. The top piece 253 and lock mechanism 254 operate as discussed above as well. The case 251 may also possess an RFID 260 or similar tracking device to prevent loss of the key fobs when vehicles are returned by drivers.

The example fobs shown in FIGS. 1-3 are shown as rectangular items. One of ordinary skill in the art may recognize that other shapes may be used to define these fobs, including circles, teardrops, ellipses, and almost any conceivable shapes. The present invention simply requires the case that is to retain two of these fobs possess a matching shape that permits the case to tightly retain the fobs in place. A different shaped case may be needed for every shape used by auto manufacturers to construct their key and key fob items.

Additionally, other key and key fob combinations are used in vehicles, most notably a folding key in which the mechanical automotive key 152 folds into a side of the key fob for storage when not in use. Because the mechanical key 152 is needed to start an ignition for a vehicle, the case 251 will need to accommodate the folding action of the key 152. In one embodiment, the slot 256 is sized to permit the key 152 to fold into and out of the case 251 while still securing the case around the two key fobs. In another embodiment, the key 152 is inserted into slot 256 before the case 251 is locked closed and the folding key is no longer able of fold. Other embodiments that are defined by the attached claims may be used as well.

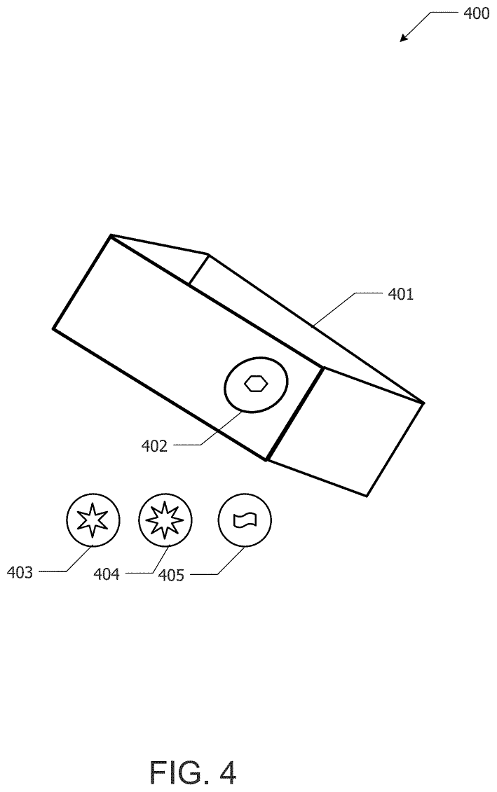

FIG. 4 illustrates an example embodiment for an article of manufacturer for providing a rental car and fleet key and key fob retention utilizing a custom headed screw to function as a locking device according to the present invention. In this embodiment, the clocking device 402 to the case 401 consists of a screw that may be easily tightened and removed but only using a non-common shaped tool. Most rental car fleets using the present invention need only deter the theft of the key fobs and requiring acquisition and use of a specialized or unique shaped locking tool may be sufficient. The head of the screw 402 may include one of a number of example shapes 403-405 that correspond to the shape a matching tool must be made, both in shape as well as size, to be able to tighten and removed the screw 402. The shapes on FIG. 4 are merely examples that one of ordinary skill in the art will recognize may use a uncommon shape to form the screw head.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. An key fob locking device may provide an article of manufacture for providing a rental car and fleet key and key fob retention device, the device comprises:
an enclosing case shaped to match an outside parameter of two or more key fobs, the outside case being open on one side with an opening sufficient to permit the key fobs to be inserted;
a top case piece shape to enclose the outside parameter of two or more key fobs when combined with the enclosing case, the top case piece coupled to a first end of the enclosing case forming a hinge such that the top piece may be positioned to completely enclosed the two or more key fobs when combined with the enclosing case;
a locking mechanism being located near a second end of the top case piece, the locking mechanism engages the second of the top case piece and the enclosing case to completely enclosed the two or more key fobs in a secure manner; and
an RFID tag coupled to an inside surface of the key fob locking device.

2. The key fob locking device according to claim 1, wherein the locking mechanism is a mechanical latch.

3. The key fob locking device according to claim 1, wherein the locking mechanism is a hex screw.

4. The key fob locking device according to claim 1, wherein the locking mechanism is a torx screw;

5. The key fob locking device according to claim 1, wherein the enclosing case further comprises at least one key slot through the side of the enclosing case sized to permit a vehicle key to pass through while enclosing the two key fobs, the vehicle key being used to turn an ignition to start the vehicle.

6. The key fob locking device according to claim 1, wherein the enclosing case further comprises at least one key slot through the side of the enclosing case sized to permit a folding vehicle key to pass through while enclosing the two key fobs, the folding vehicle key being used to turn an ignition to start the vehicle.

7. The key fob locking device according to claim 5, wherein the locking mechanism is a noncommon headed screw.

8. The key fob locking device according to claim 7, wherein the enclosing case comprises a perpendicular lip extending inward from both sides of the enclosing case to secure the two key fobs within.

9. The key fob locking device according to claim 7, wherein the top case piece comprises a perpendicular lip extending inward from both sides of the enclosing case to secure the two key fobs within.
